(19) United States
(12) Patent Application Publication
(10) Pub. No.: US 2010/0049680 A1
(43) Pub. Date: Feb. 25, 2010

(54) METHOD FOR PROJECTING WAFER PRODUCT OVERLAY ERROR AND WAFER PRODUCT CRITICAL DIMENSION

(75) Inventors: YU CHANG HUANG, TAIPEI COUNTY (TW); WEN-HSIANG LIAO, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY (TW)

(21) Appl. No.: 12/269,296

(22) Filed: Nov. 12, 2008

(30) Foreign Application Priority Data
Aug. 20, 2008 (TW) 97131692

(51) Int. Cl. G06F 15/18

(52) U.S. Cl. 706/16

(57) ABSTRACT

A method for projecting wafer product overlay error of the present invention is disclosed, the steps of the method comprises:(a) sample equipment overlay error data, equipment condition data, and actual wafer product overlay error data; (b) establish a neural network, the equipment overlay error data and the equipment condition data are inputs of the neural network, the generated output of the neural network is projected wafer product overlay error data, and the actual wafer product overlay error data is the target output of the neural network; and (c) set a mean square error target, train the neural network continuously until the mean square error of the neural network is no longer bigger than the mean square error target. Additionally a method for projecting wafer product critical dimension is also presented in the present invention.

### BACKGROUND OF THE INVENTION

1. Field of the Invention

The present invention relates to a method for projecting wafer product overlay error and wafer product critical dimension, more specifically to a method utilizing neural network for projecting wafer product overlay error and wafer product critical dimension.

2. Description of Related Art

Wafer product overlay error and wafer product critical dimension are two important factors in photolithography, so there are some measuring instruments for measuring wafer product overlay error and wafer product critical dimension in a wafer factory. An engineer reads the measurement results from the measuring instruments so as to judge whether the measured wafer products conform to the wafer specification or not, and adjust operating conditions of the relevant wafer manufacturing machine, so that when a new batch of wafers is transported to the wafer manufacturing machine whose operate conditions has been adjusted, the new batch of wafer products has a better chance of conforming to the wafer specification. However the measuring instrument do not measure every batch of wafer products in real time, so some bad wafer products are not found by the measuring instrument.

Moreover, the measuring instruments take much time to measure a batch of wafer products, when the volume of wafer products required are increased, measuring time will effect efficiency and yield of manufacturing wafer products more dramatically.

Hence, the inventors of the present invention believe that the shortcomings described above can be improved upon and finally suggest the present invention which is of a reasonable design and is an effective improvement.

### SUMMARY OF THE INVENTION

An object of the present invention is to provide a method for projecting wafer product overlay error and wafer product critical dimension, people can use the projecting method to forecast wafer product overlay error and wafer product critical dimension in real time, further enhance the efficiency of manufacturing wafer products.

Steps of a method for projecting wafer product overlay error comprise:
(a) sample equipment overlay error data, equipment condition data and actual wafer product overlay error data;
(b) establish a neural network, the equipment overlay error data and the equipment condition data are inputs of the neural network, the generated output of the neural network is projected wafer product overlay error, and the actual wafer product overlay error data is the target output of the neural network; and
(c) set a mean square error target, train the neural network continuously until the mean square error of the neural network is no longer bigger than the mean square error target.

Steps of a method for projecting wafer product critical dimension comprise:
(a) sample equipment critical dimension data, equipment condition data, and wafer product critical dimension data;
(b) establish a neural network, the equipment critical dimension data and the equipment condition data are inputs of the neural network, the generated output of the neural network is projected wafer product critical dimension, and the actual wafer product critical dimension data is the target output of the neural network; and
(c) set a mean square error target, train the neural network continuously until the mean square error of the neural network is no longer bigger than the mean square error target.

Steps of a method for projecting wafer product overlay error and wafer product critical dimension comprises:
(a) sample equipment overlay error data, equipment critical dimension data, equipment condition data, actual wafer product overlay error data, and actual wafer product critical dimension data;
(b) establish a first neural network and a second neural network, the equipment overlay error data and the equipment condition data are inputs of the first neural network, the generated output of the first neural network is projected wafer product overlay error, the actual wafer product overlay error data is the target output of the first neural network, the equipment critical dimension data and the equipment condition data are inputs of the second neural network, the generated output of the second neural network is projected wafer product critical dimension, and the actual wafer product critical dimension data is the target output of the second neural network; and
(c) set a first mean square error target and a second mean square error target, train the first neural network continuously until the mean square errors of the first neural network is no longer bigger than the first mean square error target, train the second neural network continuously until the mean square errors of the second neural network is no longer bigger than the second mean square error target.

### BRIEF DESCRIPTION OF THE DRAWINGS

FIG. 1 is a flow chart of a method for projecting wafer product overlay error according to the present invention.

FIG. 2 is a block diagram of a first neural network according to the present invention.

FIG. 3 is a figure showing the projected wafer product overlay error and the actual wafer product overlay error.

FIG. 4 is a flow chart of a method for projecting wafer product critical dimension.

FIG. 5 is a block diagram of a second neural network according to the present invention.

FIG. 6 is a figure showing the performance of the first neural network as the training continues.

### DETAILED DESCRIPTION OF PREFERRED EMBODIMENTS

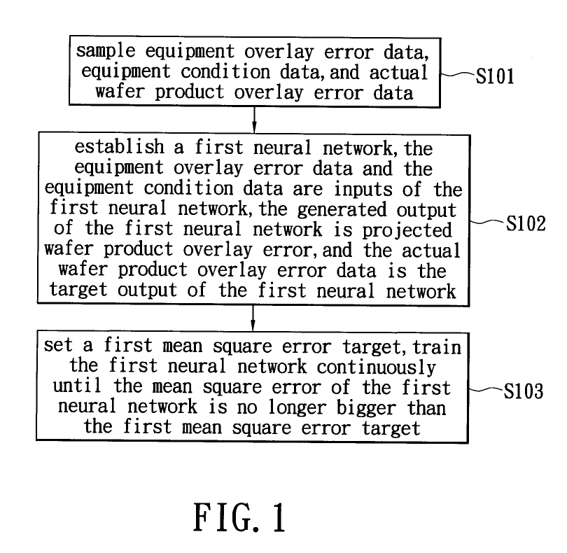

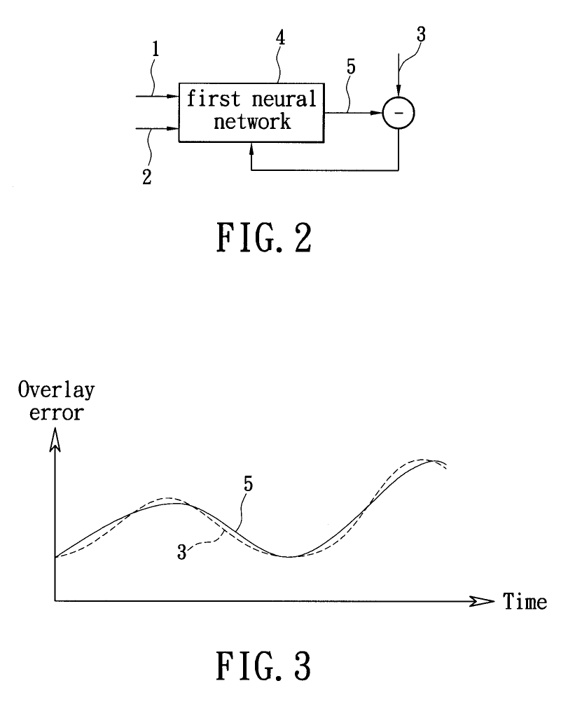

As shown in FIGS. 1 and 2, a method for projecting wafer product overlay error is presented, and the steps of the method comprise:

S101: sample equipment overlay error data 1, equipment condition data 2, and actual wafer product overlay error data 3, wherein the equipment overlay error data 1 indicates manufacturing ability of manufacturing machines, if a batch of wafers which is transported to the manufacturing machine whose manufacturing ability is better, the overlay error of the batch of wafer product is smaller;

S102: establish a first neural network 4, the first neural network 4 can be chosen as a back-propagation neural network, the equipment overlay error data 1 and the equipment condition data 2 are inputs of the first neural network 4, the generated output of the first neural network 4 is projected wafer product overlay error 5, and the actual wafer product overlay error data 3 is the target output of the first neural network 4. Therein the actual wafer product overlay error data 3 include overlay shift in x direction, overlay rotation in x direction, overlay magnification in x direction, overlay shift in y direction, overlay rotation in y direction, overlay magnification in y direction, corrected reverse overlay in x direction, corrected reverse overlay in y direction, potential rework overlay in x direction, potential rework overlay in y direction, reverse overlay in x direction, reverse overlay in y direction, and so on. Wherein the reverse overlay is composed of the potential rework overlay and the corrected reverse overlay. Furthermore the number of output neuron of the first neural network 4 must be the same as the number of the kinds of actual wafer product overlay error data 3; and

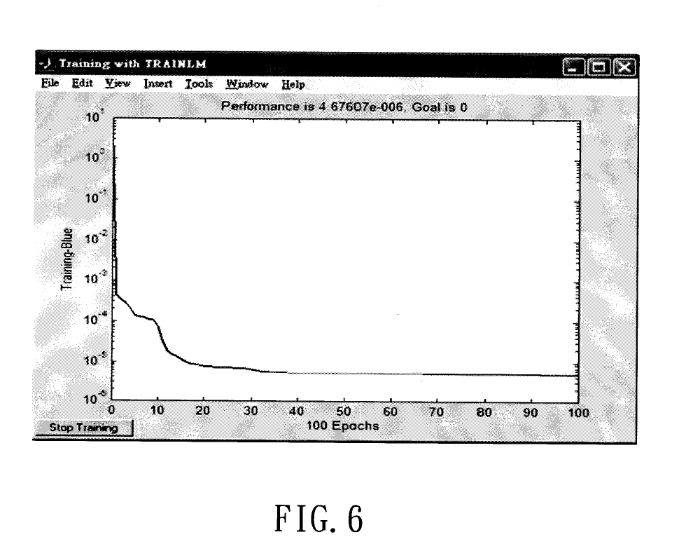

S103: set a first mean square error target, train the first neural network 4 by compensating the variance between the projected wafer product overlay error 5 and the actual wafer product overlay error data 3, train the first neural network 4 continuously until the mean square error of the first neural network 4 is no longer bigger than the first mean square error target (refer to FIG. 6). When the mean square error of the first neural network 4 is no longer bigger than the first mean square error target, the training process for the first neural network 4 is accomplished.

As shown in FIG. 3, when a new batch of wafers is transported to a manufacturing machine, when the training process for the first neural network 4 has been accomplished, the first neural network 4 can predict the overlay error of this batch of wafers via the equipment overlay error data 1 of this batch of wafers and the equipment condition data 2 of this batch of wafers. The generated output of the first neural network 4 is the projected wafer product overlay error 5, an engineer can compare the projected wafer product overlay error 5 (dashed line) with the actual wafer overlay error 3 (solid line) measured by measuring instruments or measure machines so as to estimate projection accuracy of the first neural network 4. In order to enhance the projection accuracy of the first neural network 4, an engineer can modulate some parameters of the first neural network 4, such as the number of hidden layer, the kind of activation functions, the number of neurons, the kind of input data, or the original sampling frequency. For example, if sampling action is done once every twenty batch of wafers originally, the sampling action can be changed to be done once every five batch of wafers.

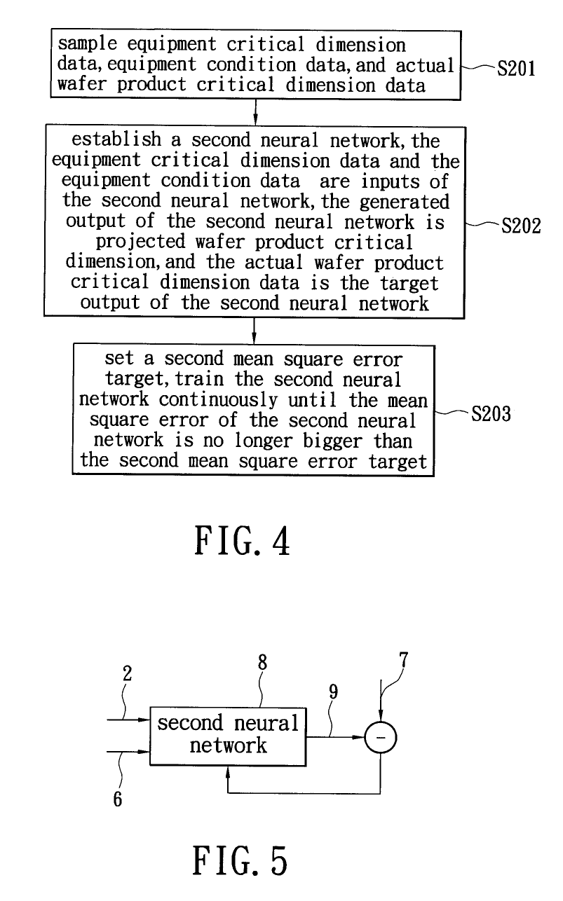

As shown in FIG. 4 and FIG. 5, a method for projecting wafer product critical dimension is presented, and the steps of the method comprise:

S201: sample equipment critical dimension data 6, equipment condition data 2, and actual wafer product critical dimension data 7, wherein the equipment critical dimension data 6 show manufacturing ability of manufacturing machines, if a batch of wafers which is transported to the manufacturing machine whose manufacturing ability is better, the critical dimension of this batch of wafer products is more accurate;

S202: establish a second neural network 8, the equipment critical dimension data 6 and the equipment condition data 2 are inputs of the second neural network 8, the generated output of the second neural network 8 is projected wafer product critical dimension 9, and the actual wafer product critical dimension data 7 is the target output of the second neural network 8. Therein, the actual wafer product critical dimension data 7 can include critical dimension mean, critical dimension range, and so on. Furthermore the number of output neurons of the second neural network 8 must be same as the number of the actual wafer product critical dimension data 7; and

S203: set a second mean square error target, train the second neural network 8 by compensating the variance between the projected wafer product critical dimension 9 and the actual wafer product critical dimension data 7, train the second neural network 8 continuously until the mean square error of the second neural network 8 is no longer bigger than the second mean square error target. When the mean square error of the second neural network 8 is no longer bigger than the second mean square error target, the training process for the second neural network 8 is accomplished.

When a new batch of wafers is transported to a manufacturing machine, when the training process for the second neural network 8 has been accomplished, the second neural network 8 can predict the critical dimension of this batch of wafer product via the equipment critical dimension data 6 of this batch of wafers and the equipment condition data 2 of this batch of wafers. An engineer can compare the projected wafer product critical dimension 9 with actual wafer product critical dimension 7 measured by measuring instruments or measure machines so as to estimate projection accuracy of the second neural network 8. In order to enhance forecast accuracy of the second neural network 8, the engineer can modulates some parameters of the second neural network 8 or the original sampling frequency.

The efficacy of the present invention is as follows: Because the first neural network and the second neural network are trained continuously by adjusting according to the variance of the projected data against the actual data, therefore wafer product overlay error and wafer product critical dimension can be predicted accurately. Additionally bad wafer products can be found by engineers, engineers don't need waste time waiting for measure data from measure machines, and the yield of wafer product and efficiency of manufacturing wafer product can be enhanced. Furthermore, a proprietor does not need to buy many measure machines, so that cost of manufacturing wafer product can be down.

What are disclosed above are only the specification and the drawings of the preferred embodiments of the present invention and it is therefore not intended that the present invention be limited to the particular embodiments disclosed. It shall be understood by those skilled in the art that various equivalent changes may be made depending on the specification and the drawings of the present invention without departing from the scope of the present invention.

What is claimed is:

1. A method for projecting wafer product overlay error, the steps of the method comprises:
Sampling equipment overlay error data, equipment condition data and actual wafer product overlay error data;
Establishing a neural network, the equipment overlay error data and the equipment condition data being inputs of the neural network, the generated output of the neural network is projected wafer product overlay error, and the actual wafer product overlay error data is the target output of the neural network; and
Setting a mean square error target, training the neural network continuously until the mean square error of the neural network is no longer bigger than the mean square error target.

2. The method for projecting wafer product overlay error according to claim 1, wherein the neural network is a back-propagation neural network.

3. The method for projecting wafer product overlay error according to claim 1, wherein the actual wafer product overlay error data includes overlay shift in x direction, overlay rotation in x direction, overlay magnification in x direction, overlay shift in y direction, overlay rotation in y direction, overlay magnification in y direction.

4. The method for projecting wafer product overlay error according to claim 1, wherein the actual wafer product overlay error data includes corrected reverse overlay in x direction and corrected reverse overlay in y direction.

5. The method for projecting wafer product overlay error according to claim 1, wherein the actual wafer product overlay error data includes reverse overlay in x direction and reverse overlay in y direction.

6. The method for projecting wafer product overlay error according to claim 1, wherein the actual wafer product overlay error data includes potential rework overlay in x direction and potential rework overlay in y direction.

7. A method for projecting wafer product critical dimension, the steps of the method comprises:
Sampling equipment critical dimension data, equipment condition data and actual wafer product critical dimension data;
Establishing a neural network, the equipment critical dimension data and the equipment condition data being inputs of the neural network, the generated output of the neural network is projected wafer product critical dimension, and the actual wafer product critical dimension data is the target output of the neural network; and
Setting a mean square error target, training the neural network continuously until the mean square error of the neural network is no longer bigger than the mean square error target.

8. The method for projecting wafer product critical dimension according to claim 7, wherein the neural network is a back-propagation neural network.

9. The method for projecting wafer product critical dimension according to claim 7, wherein the actual wafer product critical dimension data includes critical dimension mean and critical dimension range.

10. A method for projecting wafer product overlay error and wafer product critical dimension, the steps of the method comprises:
Sampling equipment overlay error data, equipment critical dimension data, equipment condition data, actual wafer product overlay error data, and actual wafer product critical dimension data;
Establishing a first neural network and a second neural network, the equipment overlay error data and the equipment condition data being inputs of the first neural network, the generated output of the first neural network is projected wafer product overlay error, the actual wafer product overlay error data is the target output of the first neural network, the equipment critical dimension data and the equipment condition data being inputs of the second neural network, the generated output of the second neural network is projected wafer product critical dimension, and the actual wafer product critical dimension data is the target output of the second neural network; and Setting a first mean square error target and a second mean square error target, training the first neural network continuously until the mean square errors of the first neural network being no longer bigger than the first mean square error target, training the second neural network continuously until the mean square errors of the second neural network being no longer bigger than the second mean square error target.

11. The method for projecting wafer product overlay error and wafer product critical dimension according to claim 10, wherein the first neural network and the second neural network is a back-propagation neural network.
